(19) United States
(12) Patent Application Publication
(10) Pub. No.: US 2018/0309189 A1
(43) Pub. Date: Oct. 25, 2018

(54) BROADBAND MIMO ANTENNA SYSTEM FOR ELECTRONIC DEVICE

(71) Applicants: Huanhuan Gu, Waterloo (CA); Enliang Wang, Waterloo (CA)

(72) Inventors: Huanhuan Gu, Waterloo (CA); Enliang Wang, Waterloo (CA)

(21) Appl. No.: 15/494,048

(22) Filed: Apr. 21, 2017

(51) Int. Cl. H01Q 1/24; H01Q 21/00; H01Q 5/30; H01Q 9/04; H01Q 1/48

(52) U.S. Cl. CPC H01Q 1/243; H01Q 21/0025; H01Q 1/48; H01Q 9/0421; H01Q 5/30

(57) ABSTRACT

An antenna and an MIMO antenna system are described. At least one antenna secured to a housing of a device. The antenna has a size of ¼ wavelength of a central frequency of the antenna and body, the ground pad and the feed pad of the antenna have an impedance matching an RF communications circuit. A plurality of the antennas may be arranged in the housing to form a MIMO antenna system.

### FIELD

The present disclosure relates to antennas, and in particular, to a broadband antenna and an arrangement of an antenna system in an electronic device.

### BACKGROUND

Ever more functionality and technology are being integrated into modern electronic devices, such as smart phones. Sometimes, additional hardware may need to be added to the electronic device in order to provide new functionality. For example, additional antennas will be required to support 5G technologies in a modern electronic device.

In a conventional mobile or wireless electronic device, the antennas may be printed on a Printed Circuit Board (PCB) of the device. There is, however, very limited additional space on the PCB for placing additional antennas, especially when the additional antennas compete with other additional hardware on the PCB. Furthermore, the layout of the PCB may need to be substantially changed or rearranged in order to print additional antennas on the ground plane of the PCB.

5G frequency bands in different countries may range from 3.5 GHz to 4.8 GHz. Therefore, it is desirable to provide additional antennas in an electronic device that covers these potential 5G frequency bands.

### SUMMARY

The present description describes example embodiments of a broadband antenna and an arrangement of an antenna system that may be conveniently implemented in an electronic device, such as a 5G electronic device. Instead of using additional impedance matching circuit between a RF communications circuit and the antenna or the antenna system, the impedance of the antenna or the antenna system described in example embodiments substantially matches an output impedance of the RF communications circuit. The antenna or antenna system may attach to a housing of the electronic device, and may be implemented in an electronic device without occupying excessive free space of the electronic device or substantially changing or rearranging the existing layout of the Printed Circuit Board.

According to one aspect there is provided an electronic device that includes a housing enclosing a radio frequency (RF) communications circuit; and a multiple input multiple output (MIMO) antenna array. The MIMO antenna array electrically connects to the RF communications circuit, the MIMO antenna array includes a first row of antennas that are secured to the housing.

Optionally, in any of the preceding aspects, the housing includes a back enclosure element surrounded by forwardly projecting rim. The first row of antennas is located in the rim.

Optionally, in any of the preceding aspects, the rim includes first and second side rim portions projecting from opposite sides of the back enclosure element. The first row of antennas is located in the first side rim portion. The MIMO antenna array includes a second row of antennas, and the second row of antennas is secured to the housing and located in the second side rim portion.

Optionally, in any of the preceding aspects, the resonant frequency of the antennas is substantially 3.5 GHz and the antennas are configured to receive or transmit RF signals within a frequency range of 3 GHz and 6 GHz.

According to another aspect, there is provided an electronic device that includes a housing enclosing a radio frequency (RF) communications circuit; and at least one antenna secured to the housing. The at least one antenna includes a resonating body with a feed pad and a ground pad extending from the resonating body. The feed pad is connected to the RF communications circuit. A ground pad is connected to a common ground as the RF communications circuit. The resonating body of the antenna has a length of ¼ wavelength of a resonant frequency of the antenna. The feed pad and the ground pad are positioned on the resonating body to provide an antenna impedance that matches an output impedance of the RF communications circuit.

Optionally, in any of the preceding aspects, the antenna impedance has a resistance in a range of 35 to 75 ohm, and a reactance about 0 to +/−20 Ohm, in the frequency range of 3-6 GHz.

Optionally, in any of the preceding aspects, a S11 of the antenna is substantially less or equal to −6 dB.

### BRIEF DESCRIPTION OF THE DRAWINGS

Reference will now be made, by way of example, to the accompanying drawings which show example embodiments of the present disclosure, and in which:

FIG. 1 is a block diagram that illustrates an example of an electronic device according to example embodiments.

FIG. 2A is a perspective view of an antenna according to example embodiments.

FIG. 2B is a left side view of the antenna in FIG. 2A.

FIG. 2C is a right side view of the antenna in FIG. 2A.

FIG. 3 is a front perspective view of a housing of the electronic device in FIG. 1, illustrating 4 antennas attached to each of two side rims, according to example embodiments.

FIG. 4 is a partial cross-sectional view of FIG. 3, illustrating an antenna with the feed pad connected to a signal circuit, according to example embodiments.

FIG. 5 is a front perspective view of a housing of a further example embodiment of the electronic device in FIG. 1, illustrating 4 antennas attached to an inner wall of each of two plastic side rims of the housing.

FIG. 6 is a partial cross-sectional view of FIG. 5, illustrating an antenna with the feed pad connected to a signal circuit, according to example embodiments.

FIG. 7 is a front perspective view of a housing of a further example embodiment of the electronic device in FIG. 1.

Similar reference numerals may have been used in different figures to denote similar components.

### DESCRIPTION OF EXAMPLE EMBODIMENTS

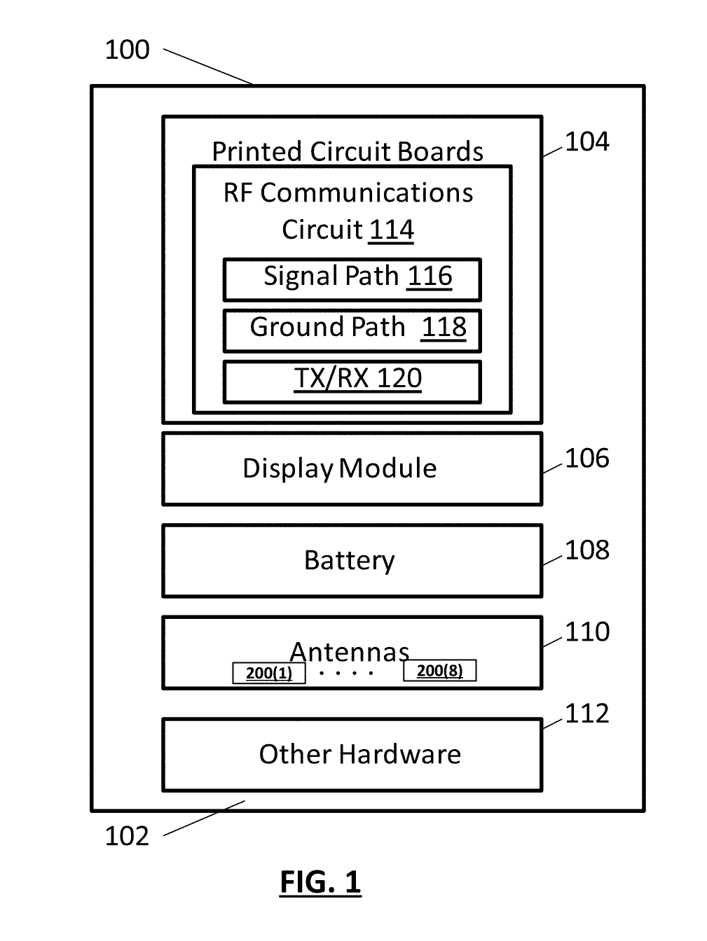

FIG. 1 illustrates an example of an electronic device 100 according to the present disclosure. The electronic device 100 may be a mobile device that is enabled to receive and/or transmit radio frequency (RF) signals including for example, a tablet, a smart phone, a Personal Digital Assistant (PDA), or an Internet of Things (IOT) device, among other things. The electronic device 100 includes a housing 102 for enclosing hardware of the electronic device 100. Hardware of the electronic device may include at least one Printed Circuit Board (PCB) 104, a display module 106, a battery 108, one or more antenna devices 110 including an array of antennas 200(1) to 200(8) (referred to generically as antennas 200), and other hardware 112 including various circuits formed by electronic components populated on the PCB 104, sensors, speakers, or cameras.

In an example embodiment, PCB 104 includes a plurality of layers including at least one signal layer and at least one ground layer. The signal layer includes a plurality of conductive traces that each form signal paths 116 between respective PCB pads. The ground layer of the PCB 104 provides a common ground reference in the PCB 104 for current returns of the electronic components and shielding, and includes a plurality of conductive traces that each form ground paths 118. Conductive vias are provided through the PCB 104 to extend the signal paths 116 and ground paths 118 to surface connection points (such as pads) on the PCB 104. Electronic components are populated on the PCB 104 to form circuits capable of performing desired functions. Electronic components may include, for example, integrated circuit (IC) chips, capacitors, resistors, inductors, diodes, transistors and other components.

In example embodiments, an RF communications circuit 114 is implemented by PCB 114 and the components populated on PCB 114. By way of example, RF communications circuit 114 can include signal and ground paths 116, 118, an RF transceiver circuit 120, electrical connectors for connecting to antenna devices 110, and other circuitry required for handling RF wireless signals. In example embodiments, RF transceiver circuit 120 can be formed from one or more integrated circuits and include modulating circuitry, power amplifier circuitry, low-noise input amplifiers and other components required to transmit or receive RF signals.

In an example, transceiver circuit 120 includes components to implement transmitter circuitry that modulates baseband signals to a carrier frequency and amplifies the resulting modulated RF signals. The amplified RF signals are then sent from the transceiver circuit 120 using signal path 116 and ground path 118 to the antennas 200 which then radiate the amplified RF signals into a wireless transmission medium. In an example, transceiver circuit 120 includes components to implement receiver circuitry that receives external carrier frequency modulated RF signals through signal path 116 and ground path 118 from the antennas 200. The transceiver circuit 120 may include a low noise amplifier (LNA) for amplifying the received signals and a demodulator for demodulating the received RF signals to baseband. In some examples, RF transceiver circuit 120 may be replaced with a transmit-only circuitry and in some examples, RF transceiver circuit 120 may be replaced with a receiver-only circuitry.

As will be explained in greater detail below, the housing 102 includes a back enclosure element with a rim or side that extends around a perimeter of the back enclosure element. A front enclosure element is provided to cooperate with the housing 102. In an embodiment, the rim, the front enclosure element and the back enclosure element together securely enclose hardware of the electronic device 100. In an embodiment, the housing 102 may be formed from material such as metal, plastic, carbon-fiber materials or other composites, glass, ceramics, or other suitable materials.

### Antenna

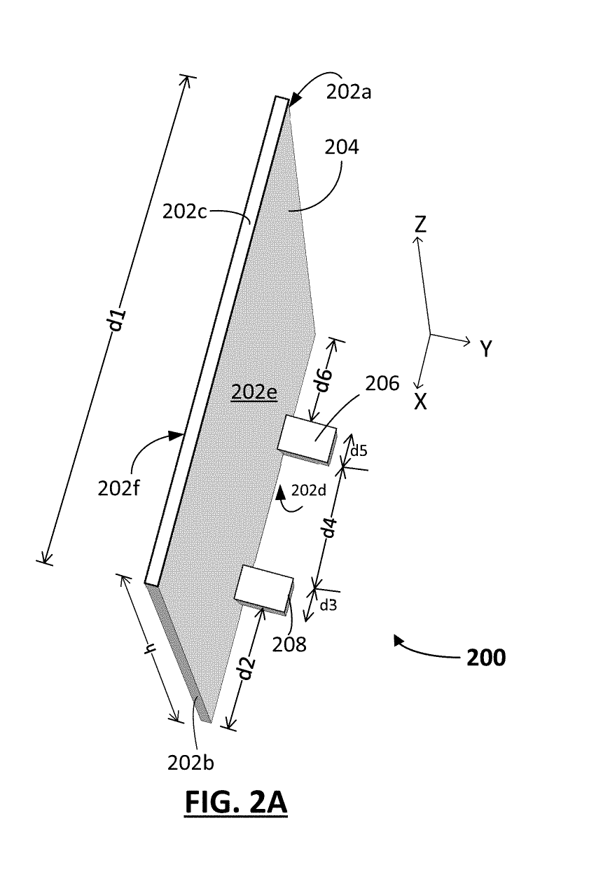

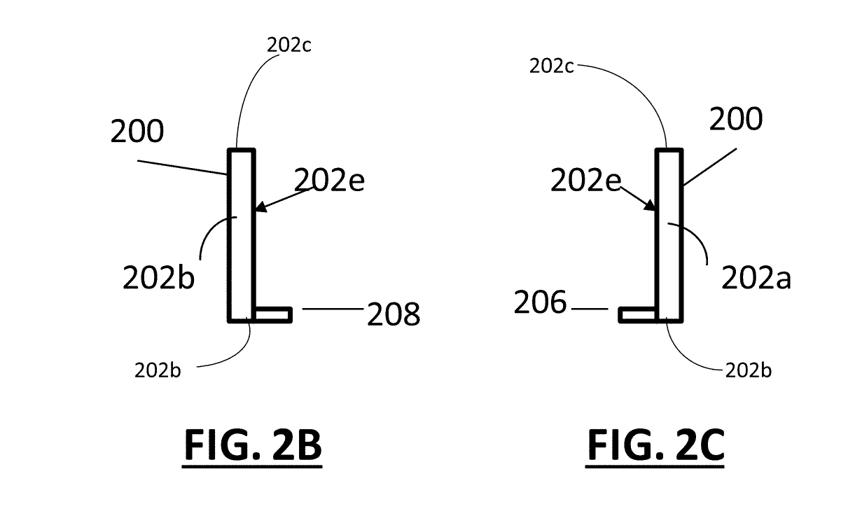

FIGS. 2A-2C illustrate an example broadband antenna 200 that is capable of transmitting RF signals received from a transmitter of the transceiver circuit 120 of the electronic device 100 and/or receiving external RF signals for further processing by a receiver of the transceiver circuit 120 of the electronic device 100. The antenna 200 comprises first and second terminals in the form of a feed pad 206, and a ground pad 208, and includes a resonating element in the form of a resonating body 204. The body 204, the feed pad 206 and the ground pad 208 may be made of metal, such as copper. The feed pad 206 and the ground pad 208 are electrically connected to the body 204.

In the example illustrated in FIG. 2A, the body 204 has a substantially rectangular shape. For example, the body 204 may be formed from a rectangular metal board that includes metal formed on a planar substrate. The body 204 includes: a planar outer side 202f, a planar inner side 202e, substantially parallel top and bottom edges 202f, 202d, and substantially parallel first and second side edges 202a, 202b that extend between top and bottom edges 202f, 202d.

Each of the feed pad 206 and the ground pad 208 has a first end electrically connected to the body 204, for example, on the inner side 202e and close to the bottom edge 202d of the body 204. Each of the feed pad 206 and the ground pad 208 extends inwardly from inner surface 202e to a respective second distal end. Each of the feed pad 206 and the ground pad 208 may have a substantially rectangular shape. For example, as shown in FIGS. 2A, 2B and 2C, each of the feed pad 206 and the ground pad 208 may be a rectangular metal tab.

The feed pad 206 is electrically connected to transceiver circuit 120 through the signal path 116 of RF communications circuit 114. The ground pad 208 is electrically connected to a common ground through the ground path 118 of the PCB 104.

In an embodiment, the feed pad 206 and the ground pad 208 are substantially perpendicular with the inner side 202e of the body 204. As illustrated in the example of FIG. 2A, the inner side 202e of the body 204 is substantially in an XZ plane, and the feed pad 206 and the ground pad 208 are substantially in the XY plane. In the illustrated embodiment, the feed pad 206 and the ground pad 208 extend inward from the inner side 201e at the bottom edge 202d of the body 204 and are located between the first side edge 202a and the second side edge 202b of the antenna body 204.

The length of the antenna body 204, illustrated as d1 in FIG. 2A, is substantially about ¼ wavelength (Δ) of the resonant frequency of the antenna 200. In FIG. 2A, the length of the antenna body 204 is d1, the distance between the feed pad 206 and the ground pad 208 is d4, the distance between the second side edge 202b and the ground pad 208 is d2, the distance between the first side edge 202a and the feed pad 206 is d6, and the widths of the feed pad 206 and the ground pad 208 are d5 and d3, respectively. In the example of FIG. 2A, d1=d2+d3+d4+d5+d6. In an embodiment, d2 and d6 are equal and d3 is equal to d5. In some embodiments, d4 is equal to the sum of d2 and d6. As will be discussed in greater detail below, in example embodiments the antenna 200 is integrated into side edge or rim portions of device 100, and in such cases the height h of the antenna 200 is selected in accordance with the thickness of the device 100.

The impedance of the antenna 200 may be denoted as a complex number Z, and Z=R+jX, where the real part of impedance is the resistance R of the antenna 200 and the imaginary part is the reactance X of the antenna 200. The reactance X may include capacitive reactance Xc and inductive reactance XL. The values of capacitive reactance Xc and inductive reactance XL change as the resonant frequency of the antenna 200 changes. When the value of the reactance X increases, the amount of reflected power of the signals transmitted between the antenna 200 and the transceiver circuit 120 increases. Impedance Z relates the voltage and current at the input, such as feed pad 206, to the antenna 200. The resistance R represents power that is either radiated away or absorbed within the antenna 200. The Reactance X represents non-radiated power that is stored in the near field of the antenna 200.

The output impedance of the RF communications circuit 114 (which includes the transceiver circuit 120 and signal and ground paths 116,118) may be purely resistive (for example, 50 Ohm). In example embodiments, the impedance Z of the antenna 200 is configured to “match” the output impedance of the RF communications circuit 114, without using any additional impedance matching circuit or impedance compensating circuit. Accordingly, in example embodiments, in the state of “impedance matching”, the antenna 200 is configured to have an impedance that has negligible reactance and has a resistance that falls within a defined range of the output resistance of the RF communications circuit 114.

In some example embodiments, where the RF communications circuit 114 impedance R=50 ohms, in the state of “impedance matching”, the antenna 200 is configured such that the impedance Z of the antenna 200 has a resistance R about 35 to 75 ohm, and a reactance X about 0 to +/−20 Ohm, at the resonant frequency and within the frequency range.

In another example embodiment, at the resonant frequency, the impedance Z of the antenna 200 is a pure resistance R (X of antenna 200 is “0”), where R is around 35-75 Ohm at the resonant frequency. In another embodiment, at the resonant frequency, the impedance Z of the antenna 200 is a pure resistance R, with R=50 Ohm.

In the state of “impedance matching”, any power loss in signals exchanged between the antenna 200 and RF communications circuit 114 is within an acceptable threshold level at the resonant frequency and within the frequency range (bandwidth) of the antenna 200. In example embodiments, the power loss in signals exchanged between the antenna 200 and RF communications circuit 114 is represented by a parameter S11, which indicates the power level reflected from the antenna 200. S11 is also known as the reflection coefficient gamma y or return loss.

In some example embodiments, at the resonant frequency and within the frequency range, S11 of the antenna 200 is <=−6 dB, i.e., at least 75% total power has been delivered to the antenna 200, and at most 25% total power has been reflected.

At a specific resonant frequency, the impedance of the antenna 200 is a factor of the distance d4 between the feed pad 206 and the ground pad 208. When d4 becomes shorter, the impedance will decrease; when d4 becomes larger, the impedance will increase. The impedance of the antenna 200 can also be a factor of the locations at which the feed pad 206 and the ground pad 208 are electrically connected to the body 204. Accordingly, in example embodiments the antenna 200 is configured such that the location of the electrical connection points of ground pad 208 and the feed pad 206 to the antenna body 204 and the distance between the ground pad 208 and the feed pad 206 achieves impedance matching within the acceptable signal power loss threshold.

In an example, the resonant frequency of the antenna 200 is 3.5 GHz. Accordingly, the length d1 of body 204 of the antenna 200 between the first and second opposite edges 202a and 202b is d1=¼λ=24 mm. The distance d6 between the feed pad 206 and the second side edge 202a is d6=5 mm, the distance d2 between the ground pad 208 and the first side edge 202b is d2=5 mm, the distance d4 between the feed pad 206 and the ground pad 208 is d4=10 mm, and the width of each of the feed pad 206 (d5) and the ground pad 208 (d3) is 2 mm. In this example, the antenna 200 has a resistance R about 35 to 75 Ohm, and a reactance X about 0 to +/−20 Ohm, and S11<=−6 dB, in the frequency range of 3 GHz to 6 GHz. In this example, the antenna 200 has a high efficiency. According to measurement results, an array of such antennas may have a total and radiation Rx efficiency of above 60% across most of the frequency range of 3 GHz to 6 GHz. As well, the antenna 200 in this example also has a good impedance matching at the frequency range of 3 GHz to 6 GHz. According to measurement results, an array of such antennas has a scattering parameter SRx-Rx substantially less than −10 dB in most of the frequency range from 3 GHz to 6 GHz.

In example embodiments, antenna 200 is a planar antenna having a structure that achieves impedance matching from 3 GHz to 6 GHz. The antenna 200 may, for example, be a Planar Inverted-F Antenna (PIFA), an Inverted-F Antenna, a monopole antenna, or a patch antenna.

Because the body 204, the feed pad 206 and the ground pad 208 of the antenna 200 have an impedance that substantially matches the output impedance of the RF communications circuit 114, the antenna 200 does not need an extra impedance matching circuit to achieve the “impedance matching” state in order for the antenna 200 to operate at the desired resonant frequency and bandwidth, for example, at resonant frequency 3.5 GHz and within the frequency range of 3 GHz-6 GHz. Therefore, antenna 200 has a compact size and may be implemented in an electronic device 100, such as a 5G electronic device, without occupying excessive free space of the electronic device 100 or substantially changing or rearranging the existing layout of the PCB 104. In example embodiments, the components of RF communications circuit 114 that connect the antenna 200 to the RF transceiver circuit 120 have negligible inductance, and the antenna 200 is configured to match the impedance of the RF transceiver circuit 120 without any intermediate RF tuning circuitry or impedance matching circuitry. In such a configuration, the configuration of the resonating element body 204 and relative positioning of feed and ground pads 206 and 208 are selected to match the impedance of RF transceiver circuit 120 to meet the criteria stated above.

### MIMO Antenna System

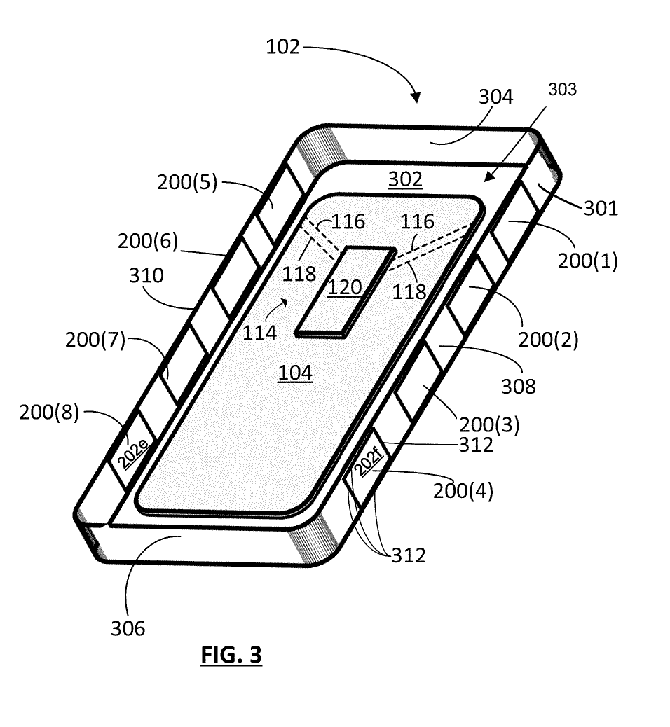

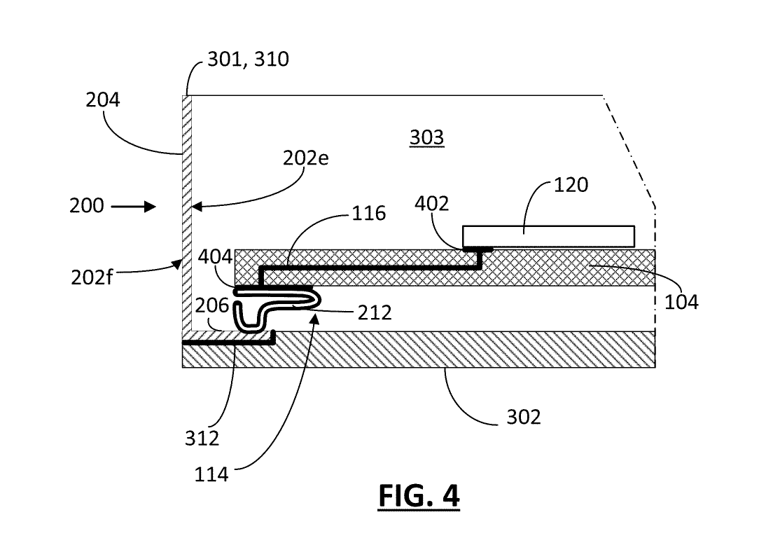

5G technologies require faster data rates and greater data streams in the air interface. A multiple-input and multiple-output (MIMO) antenna system may be used to increase the capacity of wireless channels. In example embodiments, a MIMO antenna array that includes a plurality of antennas 200 is integrated into the housing 102 of electronic device 100, and in this regard reference is now made to the example embodiment illustrated in FIGS. 3 and 4.

As illustrated in FIGS. 3 and 4, the housing 102 of electronic device 100 includes a rectangular, planar back enclosure element 302 that is surrounded by a forwardly projecting rim 301 that extends around the outer periphery of back enclosure element 302. The rim 301 and back enclosure element 302 define the back and sides of an internal region 303 that contains hardware of the device 100, including PCB 104. The electronic device 100 will typically also include a front enclosure element that is secured to the front of the rim 301 and covers the front of the internal region 303 to enclose the internal device hardware. However, in the illustration of FIG. 3, the front enclosure element is omitted for clarity. In at least some examples the front enclosure element incorporates user interface elements such as a touch display screen.

The rim 301 includes a top rim portion 304, a bottom rim portion 306 and two opposite side rim portions 308 and 310 that extend between the top and bottom rim portions. Electronic devices intended for handheld use typically have a rectangular prism configuration with a top and bottom of the device that correspond to the orientation that the device is most commonly held in during handheld use, and the terms “top”, “bottom”, “front” and “back” as used herein refer to the most common use orientation of a device as intended by the device manufacturer, while recognizing that some devices can be temporarily orientated to different orientations (for example from a portrait orientation to a landscape orientation). In some examples, the term “top” corresponds to the top edge of a display screen on the front enclosure element of the electronic device 100, with the top edge of the screen corresponding to the readable orientation of information arranged on the screen when the screen is first turned on. In some examples, “top” and “bottom” can be relative to the location of speaker and microphone elements, with the speaker being located closer to the top rim and the microphone being closer to the bottom rim. In at least some example embodiments, the side rims 308 and 310 of the housing 102 have a greater length than the top rim 304 and bottom rim 306 of the housing 102.

Each of the top rim 304, the bottom rim 306, and the two opposite side rims 308 and 310 has an inner surface and an outer surface. In an example embodiment, the back enclosure element 302 and the rim 301 are formed from suitable material, such as metal, plastic, carbon-fiber materials or other composites, glass, or ceramics, and eight antennas 200 are secured to the rim 301 of housing 102 to form an 8×8 MIMO antenna system. The feed pads 206 and the ground pads 208 of the 8 antennas 200 are arranged inside the housing 102 for electrically connecting with signal and ground paths 116, 118 of PCB 104.

In this regard, as illustrated in FIG. 3, eight antennas 200(1)-200(8) are arranged on the side rim portions 308 and 310 of the housing 102, with four antennas 200(1)-200(4) integrated into one side rim portion 308 and four antennas 200(5)-200(8) integrated into the opposite side rim portion 310. The antennas 200(1)-200(8) form part of the metal rim 301 of the side rim portions 308 and 310 with the inner side 202e of each antenna facing into the internal region 303 of housing 102 and the outer side 202f of each antenna facing outwards. In one example, the antennas 200 are each secured into respective openings in the side rim portions 308 and 310 using an insert molding process with an insulating dielectric material 312 (see antenna 200(4)) extending around a perimeter of the antenna feed and ground pads 206, 208 and antenna body 204 to insulate the antenna 200 from the rest of the metal of housing 102 and secure the antenna 200 in place. In some examples, insulating material 312 could include a plastic strip. In an example embodiment the antennas 200(1)-200(4) are evenly spaced apart in a row along side rim portion 308 and the antennas 200(5)-200(8) are evenly spaced apart in a row along opposite side rim portion 310. In the illustrated example, the antennas 200(1)-200(4) are symmetrical with respect to the antennas 200(5)-200(8).

In FIG. 3, the inner side 202e of the metal antenna body 204 of each of the antennas 200(1)-200(8) forms part of the inner surface of the side rim portions 308 and 310, and the outer side 202f of the metal antenna body 204 of each of the antennas 200(1)-200(8) forms part of the outer surface of the side rim portions 308 and 310. In an embodiment, the thickness of the body 204 of the antennas 200a-200h and the non-antenna portions of side rim portions 308 and 310 are substantially the same, however in some example embodiments they may be different.

As noted above, an RF transceiver circuit 120 is mounted on PCB 104. Signal paths 116 and ground paths 118 (illustrated as dashed lines in FIG. 3, which shows two of the eight sets of signal and ground paths 116, 118) are provided in respective layers of the PCB 104 between the RF transceiver circuit 120 to provide signal and ground connections between each of the antennas 200 and the RF transceiver circuit 120. FIG. 4 is a partial cross-sectional illustration of the device 100 of FIG. 3, showing the connection of feed pad 206 of an antenna 200 (for example antenna 200(7)) to transceiver circuit 120 through a signal path 116 of PCB 104. As shown in FIG. 4 and discussed above, the body 204 of antenna 200 forms part of the rim 301 (side rim portion 310 in the case of antenna 200(7)) of housing 102, with the inner side 202e of the antenna 200 facing housing inner region 303, and the outer side 202f of the antenna 200 facing outwards. The feed pad 206 of antenna 200 extends inward from the antenna body 204 and is integrated into an upper surface of the metal bottom enclosure element 302 such that a surface of the feed pad 206 is exposed in housing inner region 303. In the illustrated embodiment, dielectric insulating material 312 extends between the metal bottom enclosure 302 and the components of antenna 200 (including feed pad 206 and ground pad 208) to insulate the antenna components from the metal bottom enclosure element 302.

In the embodiment of FIG. 4, signal path 116 extends through PCB 104 between a first conductive pad 402 located on one side of the PCB 104 and a second conductive pad 404 located on the opposite side of the PCB. A signal input/output pad of RF transceiver circuit 120 is electrically connected (for example through a wave soldering process) to the first conductive pad 402. A connector, such as a spring loaded pressure contact connector, 212 is connected (for example through a wave soldering process) to the second conductive pad 404. When PCB 104 is secured within the housing 102 (which may occur through known techniques such as screws and/or clips for example), the spring loaded connector 212 is clamped between the PCB 104 and the antenna feed pad 206, biasing the connector 212 into electrical contact with feed pad 206, thus providing a RF signal path between the RF transceiver circuit 120 and the antenna 200. Although not shown in FIG. 4, the ground pad 208 of antenna 200 is similarly electrically connected by a further spring loaded connector to a ground path 118 in PCB 104.

From the perspective of antenna 200, the spring loaded connectors 212, PCB signal path 116 and ground path 118, RF transceiver circuit 120, and any interconnecting conductive elements such as PCB pads 402, 404, collectively provide RF communications circuit 114. As noted above in example embodiments, the impedance of antenna 200 is matched as per the criteria described above to the impedance of the RF communications circuit 114. In at least some example embodiments, the impedance of the connectors 212, PCB paths 116 and 118 and any interconnecting conductive elements such as PCB pads 402, 404 is general negligible and can be ignored in impedance matching of the antenna 200 and the RF transceiver circuit 120. In example embodiments, the antenna 200 is impedance matched to the RF transceiver circuit 120 based on the configuration of the antenna body 204 and the location of the ground and feed pads 208, 206 without the need for any intermediate impedance matching circuitry on the antenna 200 or in the signal path between the antenna 200 and the transceiver circuit 120. As indicated above, in some examples the transceiver circuit 120 may be replaced with a receiver only circuit or a transmitter only circuit.

Different electrical connections can be used between the antenna 200 and the PCB 104 than the spring clip style connector 212 shown in FIG. 4. For example, a spring loaded pogo-pin style connector could alternatively be used.

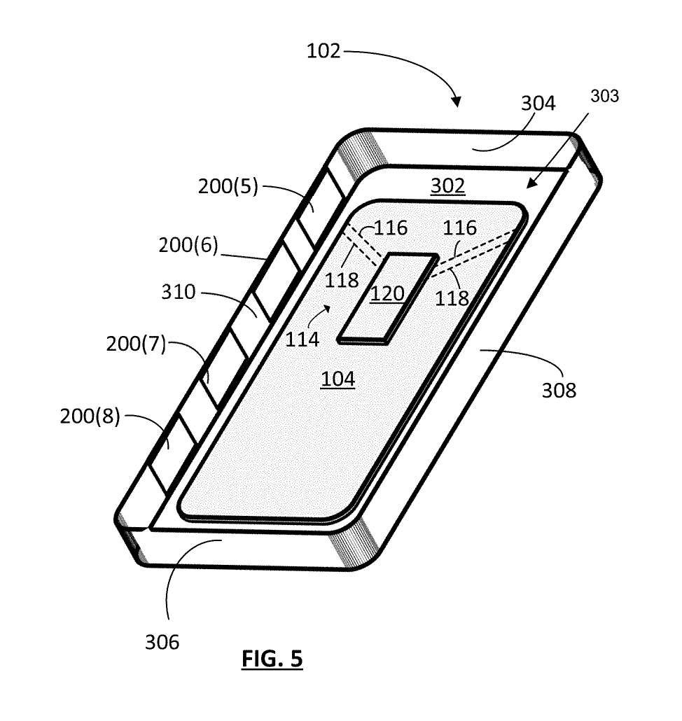

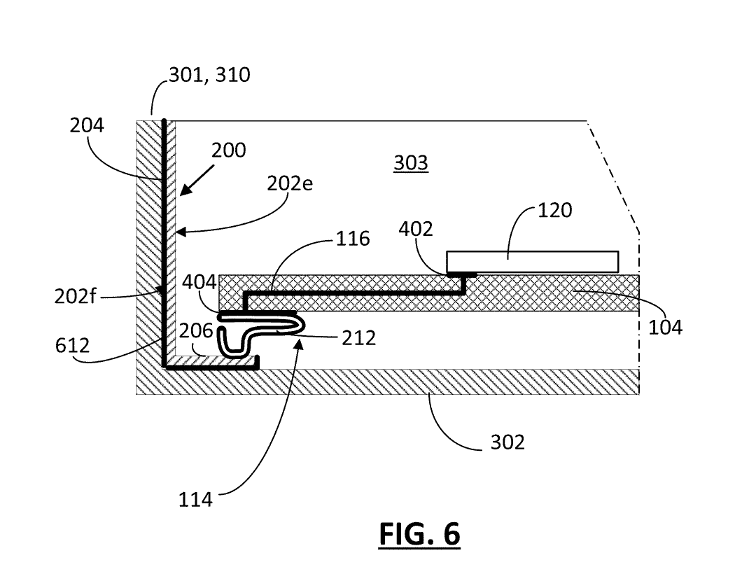

In the embodiment of FIGS. 3 and 4, housing 102 is formed from substantially metallic components. In other example embodiments, the housing 102 of electronic device 100 is formed from plastic components, and in this regard FIGS. 5 and 6 illustrate a further example embodiment that is substantially similar to the previously described embodiments except for differences that will be apparent form the description and the Figures. In the example of FIGS. 5 and 6, antennas 200(1)-200(8) are arranged to securely attach to the inner surfaces of the side rim portions 308 and 310 of the housing 102, which is formed from a plastic material. As illustrated in FIG. 5, antennas 200(5)-200(8) are arranged on the inner surface of side rim portion 310 of the housing 102. Antennas 200(1)-200(4) arranged on the inner surface of side rim portion 308 are not shown because they are hidden in the perspective view of FIG. 5. The thickness of the body 204 of the metal antennas 200(1)-200(8) and the side rim portions 308, 310 may be different or substantially the same.

In example embodiments, the antennas 200(1)-200(8) are be securely attached to the inner surfaces of side rim portions 308 and 310 using a laser direct structuring (LDS) process. In another embodiment, the antennas 200(1)-200(8) are securely attached to the inner surfaces of side rim portions 308 and 310 by a flex tape process in which each of the antennas 200(1)-200(8) are mounted on a respective flex PCB that is then mounted using an adhesive with the antennas to the inner surfaces the side rim portions 308 and 310.

The partial sectional view of FIG. 6 illustrates the mounting an antenna 200 (for example antenna 200(7)) to the plastic side rim portion 310 of rim 301 in greater detail. As shown in FIG. 6, the body 204 of antenna 200 is secured to the inner surface of rim portion 310, with the inner side 202e of the antenna 200 facing housing inner region 303, and the outer side 202f of the antenna 200 facing the rim portion 310, which is formed from a non-conductive RF-transparent material. The feed pad 206 of antenna 200 extends inward from the antenna body 204 along a non-conducting upper surface of the bottom enclosure element 302 such that a surface of the feed pad 206 is exposed in housing inner region 303. In an example where an LDS process is used, the antenna 200 may be integrally formed on the rim portion 310 and bottom enclosure element 302.

In an example where a flex tape process is used, antenna 200 can be integrated into flex PCB 312 that is secured to the rim portion 310 and bottom enclosure element 302.

The electrical connection of the feed and ground pads 206 and 206 to RF signal circuit are the same as described above in respect of FIGS. 3 and 4.

In the embodiments shown in FIGS. 3 to 6, the PCB 104 of the electronic device 100 is generally arranged to be parallel to bottom enclosure element 302 and may be secured to standoffs that are located on the bottom enclosure element 302. The body 204 of the antenna 200 is arranged substantially perpendicular with the feed pad 206 and ground pad 208, and this arrangement facilitates connecting the antenna 200 attached to the rim 301 of housing 102 to the ground and feed paths of PCB 104 through spring loaded pressure contact connectors 212.

In an embodiment, antennas 200 attached to the housing 102 may be planar antennas. For example, the planar antennas may be Planar Inverted-F Antennas (PIFAs), Inverted-F Antennas, monopole antennas, and patch antennas.

Because the antennas in the MIMO antenna systems of FIGS. 3 and 5 are attached to two side rims 308 and 310 of housing 102, the MIMO antenna systems do not require additional free space from the PCB 104. As such, when additional antennas are required for the electronic devices 100 to provide additional functions or services, for example additional 5G antennas to provide 5G communications services, the additional antennas may be implemented within the electronic device 100, without occupying excessive free space of the electronic device 100 or substantially changing or rearranging the existing layout of the PCB 104.

In different embodiments, the number, location and relative spacing of antennas 200 within the housing 102 can be different than described above. For example, one or more antennas 200 could be placed on the top rim portion 304, the bottom rim portion 306, the back enclosure element 302 and/or the front cover of the housing 102. The antennas can be asymmetrically placed in some examples. In some examples, the number of antennas could be fewer than or greater than eight, including as few as one. In some examples, 4 antennas 200 may securely attach to the housing 102 to form a 4×4 MIMO antenna system, including for example 2 antennas 200 secured to each of the side rim portions 308 and 310 of the housing 102 to form a 4×4 MIMO antenna system. In a further example, 12 antennas 200 may be secured to the housing 102 to form a 12×12 MIMO antenna system, including for example 6 antennas 200 secured to each of the side rim portions 308 and 310 of the housing 102 to form a 12×12 MIMO antenna system.

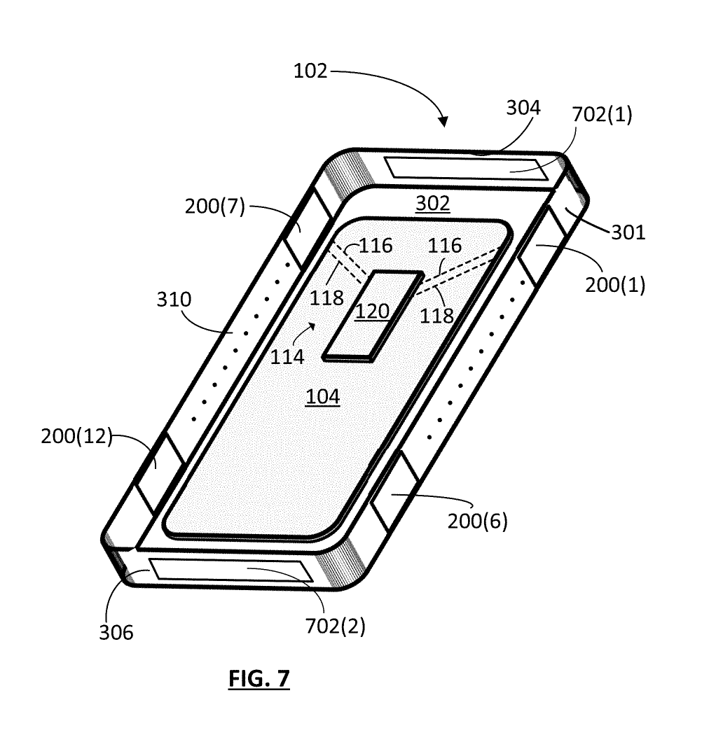

In examples described above, the antennas 200 secured to the housing 102 are substantially identical to each other and have a resonant frequency with the frequency range of 3 GHz-6 GHz. In some example embodiments, the antennas 200 secured to the housing 102 have different resonant frequencies with the frequency range of 3 GHz-6 GHz. For example, within the frequency range of 3 GHz-6 GHz, a plurality of antennas 200 securely attached to side rim 308 of housing 102 have a resonant frequency of 3.5 GHz, a plurality of antennas 200 securely attached to side rim 310 of housing 102 have a resonant frequency of 4.8 GHz. In other example embodiments, a plurality of antennas 200 securely attached to a side rim 308 or 310 of housing 102 have different resonant frequencies. For example, on a side rim 308 or 310, some of the antennas 200 have a resonant frequency of 3.5 GHz and other antennas 200 have a resonant frequency of 4.8 GHz. In other example embodiments, antennas having different configurations and tuned for other frequency ranges are also secured to housing 102, including for example antennas for 3.5 GHz, 4.8 GHz and sub 2.6 GHz legacy bands. In this regard, FIG. 7 illustrates an example embodiment of a housing 102 which includes a 12×12 array of 3 GHz-6 GHz antennas 200(1)-200(12), and also includes a first sub 2.6 GHz antenna 702(1) secured to top rim portion 304 and a second sub 2.6 GHz antenna 702(2) secured to bottom rim portion 306. The antennas 702(1) and 702(2) may, in some examples, be connected to a different transceiver circuit than antennas 200, and may be secured to rim 301 in a different manner than antennas 200.

In some example embodiments, antennas secured to the housing 102 have different resonant frequencies and different frequency ranges.

### Performance of the 8×8 MIMO Antenna System

In some examples, MIMO antenna systems such as those shown in in FIGS. 3 and 5 have a low correlation between different pairs of antennas 200. For example, according to measurement results of an 8×8 MIMO antenna analyzer EMITE chamber, the Rx-Rx Envelope Correlation Coefficient (Pearson) are substantially below 0.1 on the bandwidth from 3 GHz to 6 GHz. Because of the low correlation between different pairs of antennas, each of the antennas can function independently from the others, and this in turn maximizes wireless channel capacity represented by each antenna 200.

MIMO antenna systems in FIGS. 3 and 5 can have a high efficiency in some configurations. According to measurement results of an 8×8 MIMO antenna analyzer EMITE chamber, the MIMO antenna systems in FIGS. 3 and 5 have a total and radiation Rx efficiency above 60% in most the frequency range from 3 GHz to 6 GHz.

The MIMO antenna systems in FIGS. 3 and 5 also have a good impedance matching with the output impedance of a signal circuit 214, such as a transmitting and/or receiving circuit, of the electronic device 100 at the frequency range of 3 GHz to 6 GHz. According to measurement results of an 8×8 MIMO antenna analyzer EMITE chamber, the MIMO antenna systems in FIGS. 3 and 5 have scattering parameters SRx-Rx equal or substantially less than −6 dB from 3 GHz to 6 GHz.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, while the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. The subject matter described herein intends to cover and embrace all suitable changes in technology.

1. An electronic device comprising:
a housing enclosing a radio frequency (RF) communications circuit; and
a multiple input multiple output (MIMO) antenna array electrically connected to the RF communications circuit, the MIMO antenna array including a first row of antennas that are secured to the housing.

2. The electronic device of claim 1 wherein the housing comprises a back enclosure element surrounded by forwardly projecting rim, wherein the first row of antennas is located in the rim.

3. The electronic device of claim 2 wherein the rim includes first and second side rim portions projecting from opposite sides of the back enclosure element, the first row of antennas being located in the first side rim portion, the MIMO antenna array including a second row of antennas, the second row of antennas being secured to the housing and located in the second side rim portion.

4. The electronic device of claim 3 wherein the first row of antennas and the second row of antennas each include at least four antennas.

5. The electronic device of claim 4 wherein the resonant frequency of the antennas is between 3 GHz and 6 GHz.

6. The electronic device of claim 4 wherein the resonant frequency of the antennas is substantially 3.5 GHz and the antennas are configured to receive or transmit RF signals within a frequency range of 3 GHz and 6 GHz.

7. The electronic device of claim 3 wherein the first and second side rim portions are formed from metal, the antennas each being insert molded into the rim and having an outer surface forming part of an outer surface of the rim.

8. The electronic device of claim 3 wherein the first and second side rim portions are formed from plastic, the antennas each being formed on the rim using a laser direct structuring (LDS) process.

9. The electronic device of claim 3 wherein the first and second side rim portions are formed from plastic, the antennas each being integrated into a flex printed circuit board (PCB) secured to the rim.

10. The electronic device of claim 3 wherein the antennas are Planar Inverted-F Antennas (PIFAs)

11. The electronic device of claim 3 wherein the rim includes a top rim portion and a bottom rim portion that extend between the first and second side rim portions at a top and bottom of the housing respectively, the electronic device further including at least one further antenna located in one of the top rim portion and the bottom rim portion, the at least one further antenna having a different resonant frequency than the resonant frequency of the antennas of the MIMO antenna array.

12. The electronic device of claim 3 wherein each of the antennas includes a resonating body secured to the rim, and a feed pad and a ground pad projecting from the resonating body into an inner region of the housing, the resonating body having a length of ¼ of the resonant frequency wavelength.

13. The electronic device of claim 12 wherein the RF communications circuit includes: an RF transceiver circuit comprising at least one integrated circuit component mounted on a printed circuit board (PCB); a plurality of signal paths extending through the PCB from the RF transceiver circuit to a plurality of electrical signal path connectors, each of the signal path connectors being in electrical contact with the feed pad of a respective one of the antennas; and a plurality of ground paths extending through the PCB from a common ground to a plurality of electrical ground path connectors, each of the ground path connectors being in electrical contact with the ground pad of a respective one of the antennas.

14. The electronic device of claim 13 wherein each of the signal path connectors and ground path connectors are spring biased to maintain pressure contact with the feed pads and ground pads, respectively.

15. The electrical device of claim 13 wherein the resonating body and feed and ground pads of each of the antennas are configured to match an output impedance of the RF transceiver circuit without any intervening impedance matching circuitry.

16. An electronic device comprising:
a housing enclosing a radio frequency (RF) communications circuit; and
at least one antenna secured to the housing, the at least one antenna comprising a resonating body with a feed pad and a ground pad extending from the resonating body, the feed pad being connected to the RF communications circuit and a ground pad connected to a common ground as the RF communications circuit,
the resonating body of the antenna having a length of ¼ wavelength of a resonant frequency of the antenna, wherein the feed pad and the ground pad are positioned on the resonating body to provide an antenna impedance that matches an output impedance of the RF communications circuit.

17. The electronic device of claim 16, wherein the housing comprises a back enclosure element and a forward projecting rim about a perimeter of the back enclosure element, the resonating body of the antenna being located on the rim.

18. The electronic device of claim 17 wherein the rim includes a top rim portion located at a top of the electronic device, a bottom rim portion, and two opposite side rims extending between the top and bottom rims, the electronic device comprises a MIMO antenna array that includes a first row of the antennas and a second row of the antennas, the resonating bodies of the first row of antennas being located on one of the side rims and the antennas of the resonating bodies of the second row of antennas being located on the other of the side rims.

19. The electronic device of claim 18, wherein the first row and the second row of antennas each include at least four of the antennas.

20. The electronic device of claim 16, wherein the antenna impedance has a resistance in a range of 35 to 75 ohm, and a reactance about 0 to +/−20 Ohm, in the frequency range of 3-6 GHz and wherein the output impedance of the RF communications circuit is 50 ohm.

21. The electronic device of claim 16, wherein a S11 of the antenna is substantially less or equal to −6 dB.

22. A method for installing a MIMO antenna array in an electronic device, the electronic device comprising a radio frequency (RF) communications circuit received within a housing for receiving the hardware, the method comprising:
securing a row of antennas that each have a same resonant frequency to the housing, each antenna having a feed pad and a signal pad extending from a resonating body; and
connecting the feed pads to signal paths of the RF communications circuit and connecting the ground pads to a common ground.
